(19) United States
(12) Patent Application Publication
(10) Pub. No.: US 2013/0285900 A1
(43) Pub. Date: Oct. 31, 2013

(54) MANIPULATING DEVICE AND DIRECTIONAL INPUT APPARATUS USING THE SAME

(71) Applicant: KYE SYSTEMS CORP., New Taipei (TW)

(72) Inventor: Chih-Min LIU, New Taipei (TW)

(73) Assignee: KYE SYSTEMS CORP., New Taipei (TW)

(21) Appl. No.: 13/867,157

(22) Filed: Apr. 22, 2013

(30) Foreign Application Priority Data
Apr. 25, 2012 (TW) 101114792

(51) Int. Cl. G06F 3/041

(52) U.S. Cl. CPC G06F 3/0414
USPC 345/156

(57) ABSTRACT

A manipulating device includes a first coil, an action unit, a control unit, a modulation unit, and a second coil. The first coil receives a charging signal to incur electromagnetic resonance, so as to generate an electric signal. The action unit generates an action signal. The control unit alternately generates a first control signal according to the electric signal in a first period and a second control signal according to the action signal in a second period. The modulation unit modulates the first control signal and the second control signal to generate a first modulated signal. The second coil generates an output signal according to the first modulated signal. A directional input apparatus uses the manipulating device and a sensing device to generate a directional control input signal. Therefore, the manipulating device uses the modulation unit and the second coil to transmit the output signal to the sensing device.

### CROSS-REFERENCE TO RELATED APPLICATION

The present application is based on, and claims priority from, Taiwan Application Serial Number 101,114,792, filed on Apr. 25, 2012, the disclosure of which is hereby incorporated by reference herein in its entirety.

### BACKGROUND

1. Technical Field

The disclosure relates to a manipulating device and a directional input apparatus using the manipulating device, and more particularly to an electromagnetic manipulating device and an electromagnetic directional input apparatus using the electromagnetic manipulating device.

2. Related Art

Along with popularization of a multimedia computer, the multimedia computer has become a tool of work or entertainment for most users. The user may use a mouse, a track ball, a keyboard, or a digital tablet as a peripheral input device to give inputs to the multimedia computer. It is the manner most satisfying a writing habit of the user that a writing area of the digital tablet and a digital pen are used to input letters or graphs to the multimedia computer. In order to better satisfy the writing habit, the digital pen can detect a pen pressure of the digital pen applied by the user to the digital tablet, so that lines of different strength can be drawn.

In order to transmit pen pressure information, an existing digital pen uses an oscillator circuit to generate an oscillation signal having a modulated frequency, and transmits the oscillation signal to a digital tablet. The digital tablet analyzes the modulated frequency of the oscillation signal to obtain a level of the pen pressure. As required by the user, a total number of levels of the pen pressure can be up to 1024. A required bandwidth is too large, so that an anti jamming capability of the digital tablet decreases. Further, power consumption of the oscillator circuit is very large, incurring a considerable burden to the digital pen.

Additionally, a power source required by the digital pen obtains power mainly in two manners: in one manner, a disposable battery is used for power supply, and in the other manner, power is obtained through electromagnetic resonance. The power supply via the disposable battery incurs inconvenience to the user, and is not environmentally friendly. The conventional power supply via the electromagnetic resonance has defects such as that implementation requires quite a lot of capacitive units, the cost is high, and the volume of the digital pen is increased.

### SUMMARY

The disclosure provides a manipulating device and a directional input apparatus using the manipulating device.

The manipulating device comprises a first coil, at least one action unit, a control unit, a modulation unit, and a second coil. The first coil is used for receiving a charging signal, and incurs electromagnetic resonance through the charging signal, so as to generate an electric signal. The action unit is used for generating at least one action signal. The control unit is connected to the first coil and the action unit, and is used for alternately generating a first control signal according to the electric signal in a first period and generating a second control signal according to at least one action signal in a second period. The modulation unit is connected to the control unit, and is used for modulating the first control signal and the second control signal to generate a first modulated signal. The second coil is connected to the modulation unit, and is used for generating an output signal according to the first modulated signal.

The directional input apparatus comprises a sensing device and the manipulating device. The sensing device comprises a power supply coil and a sensing unit. The power supply coil is used for generating a charging signal, and the sensing unit generates a directional control input signal according to an output signal.

According to an embodiment, the action unit is a pen pressure detector or a button. The manipulating device further comprises a rectifier circuit. The rectifier circuit is connected to the first coil and the control unit, and is used for rectifying the electric signal, and outputting the rectified electric signal to the control unit.

In this and some other embodiments, the modulation unit of the manipulating device comprises a modulation circuit and a clip circuit. The modulation circuit is connected to the control unit, and is used for generating a second modulated signal according to the first control signal and the second control signal. The clip circuit is connected to the modulation circuit and the second coil, and is used for clamping a voltage of the second modulated signal to generate the first modulated signal.

In this and some other embodiments, the charging signal is at a first frequency. The output signal has the first frequency and a plurality of high order harmonics of the first frequency.

In this and some other embodiments, the clip circuit comprises a first Zener diode, a second Zener diode, and a matching capacitor. The first Zener diode is used for clamping a positive half cycle of the second modulated signal. The second Zener diode is used for clamping a negative half cycle of the second modulated signal. The matching capacitor matches the first coil to generate the high order harmonics.

In this and some other embodiments, a center frequency of the high order harmonics is a plurality of times of the first frequency.

In this and some other embodiments, the sensing unit of the directional input apparatus filters the output signal to obtain the first control signal and the second control signal, and generates the directional control input signal according to the first control signal and the second control signal.

### BRIEF DESCRIPTION OF THE DRAWINGS

The disclosure will become more fully understood from the detailed description given herein below for illustration only, and thus does not limit the disclosure, wherein:

FIG. 1 is a schematic block diagram of a manipulating device according to an embodiment;

FIG. 2 is a schematic block diagram of a directional input apparatus according to an embodiment;

FIG. 3A is a schematic block diagram of a manipulating device according to an embodiment;

FIG. 3B is a schematic block diagram of a manipulating device according to an embodiment;

FIG. 4 is a circuit diagram of a modulation unit according to an embodiment;

FIG. 5 shows a conversion curve of a clip circuit according to an embodiment;

FIG. 6A is a waveform diagram of a second modulated signal according to an embodiment;

FIG. 6B is a waveform diagram of a first modulated signal according to an embodiment; and

FIG. 7 is a schematic block diagram of a sensing unit according to an embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The disclosure provides a manipulating device and a directional input apparatus using the manipulating device, which can be used as peripheral devices of a computer. A user can operate the manipulating device, so as to use the directional input apparatus to control a cursor displayed by the computer and operate the computer.

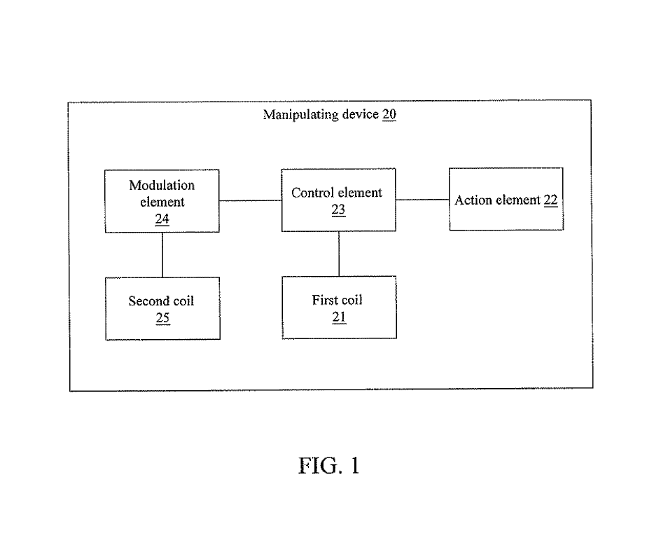

Referring to FIG. 1, FIG. 1 is a schematic block diagram of a manipulating device according to an embodiment. A manipulating device 20 comprises a first coil 21, at least one action unit 22, a control unit 23, a modulation unit 24, and a second coil 25.

The first coil 21 is used for receiving a charging signal, and incurs electromagnetic resonance because of the charging signal, so as to generate an electric signal. The electric signal is transmitted by the first coil 21 to the control unit 23. In this and some other embodiments, the electric signal acts as a power source to supply the action unit 22, the control unit 23, the modulation unit 24, and the second coil 25 in the manipulating device 20, so that no battery is required in the manipulating device 20. Therefore, the user can directly use the manipulating device 20 without charging the manipulating device 20 or replace a battery in advance. In an embodiment, the first coil 21 is directly connected to the aforementioned units, so that the electric signal is directly transmitted by the first coil 21 to the aforementioned units. In an embodiment, the first coil 21 is only connected to the control unit 23. Therefore, the electric signal is only transmitted to the control unit 23, and the control unit 23 supplies power to the other units.

In this and some other embodiments, the action unit 22 is a pen pressure detector or a button, and is used for generating at least one action signal. In this and some other embodiments, the outward appearance of the manipulating device 20 is in the shape of a pen, at least one button is arranged on an outer side of a pen shaft, and the pen pressure detector is arranged at a pen nib. The action unit 22 generates an action signal according to whether the button is pressed or according to a detected pen pressure.

The control unit 23 is connected to the first coil 21 and the action unit 22, and is used for alternately generating a first control signal according to the electric signal in a first period and generating a second control signal according to at least one action signal in a second period. In this and some other embodiments, the control unit 23 is a Micro Control Unit (MCU) or an encoder. The control unit 23, according to the electric signal, generates the first control signal for positioning, and encodes the action signal into the second control signal. In order to have both the function of positioning the manipulating device 20 and the function of transmitting extra information such as the pen pressure, the control unit 23 alternately outputs the first control signal and the second control signal. In this and some other embodiments, the control unit 23 performs outputting in a sequence of the first control signal, the second control signal, the first control signal, and the second control signal.

The modulation unit 24 is connected to the control unit 23, and alternately receives the first control signal and second control signal from the control unit 23. The modulation unit 24 is used for modulating the first control signal and the second control signal to generate a first modulated signal. A detailed circuit and operation of the modulation unit 24 are described later. The second coil 25 is connected to the modulation unit 24, and is used for generating an output signal according to the first modulated signal.

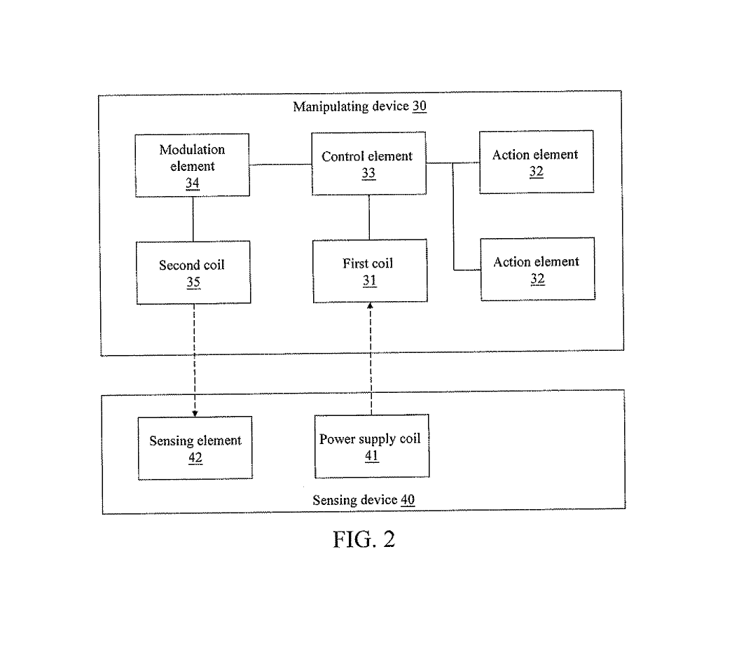

Referring to FIG. 2, FIG. 2 is a schematic block diagram of a directional input apparatus according to an embodiment.

The directional input apparatus comprises a manipulating device 30 and a sensing device 40. According to an embodiment, the manipulating device 30 is a digital pen, and the sensing device 40 is a digital tablet. The sensing device 40 corresponds to the manipulating device 30. The manipulating device 30 is disposed on a working area of the sensing device 40.

The manipulating device 30 is the same as the manipulating device 20 in FIG. 1. Operation of a first coil 31, an action unit 32, a control unit 33, a modulation unit 34 and a second coil 35 in the manipulating device 30 is the same as that of the first coil 21, the action unit 22, the control unit 23, the modulation unit 24, and the second coil 25 in the manipulating device 20.

The sensing device 40 comprises a power supply coil 41 and a sensing unit 42. The power supply coil 41 is used for generating a charging signal, and sending the charging signal to the first coil 31 of the manipulating device 30. Specifically, in this and some other embodiments, the power supply coil 41 is formed of a toroidal wire. While receiving an alternating current (AC) current, the power supply coil 41 converts the AC current into an electromagnetic wave. Electromagnetic induction is incurred between the first coil 31 and the power supply coil 41, so that the charging signal is received by the first coil 31 and is sent by the power supply coil 41 wirelessly. The sensing unit 42 receives, through electromagnetic induction, the output signal sent by the second coil 35, and generates a directional control input signal according to the output signal.

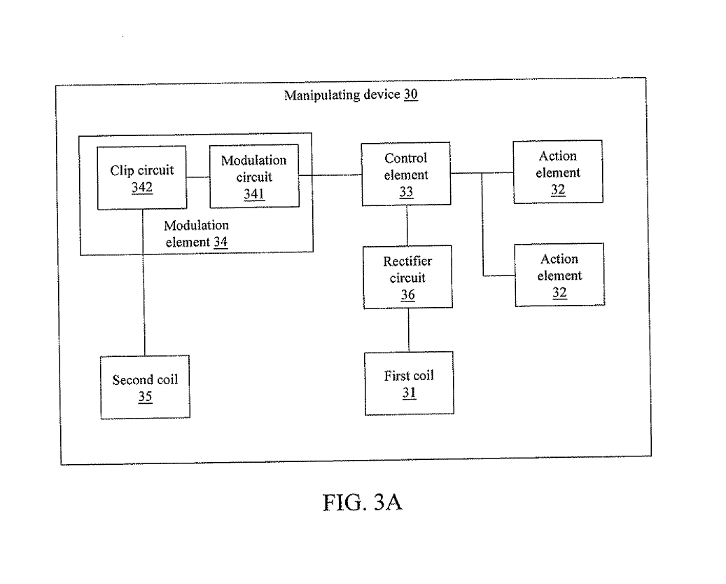

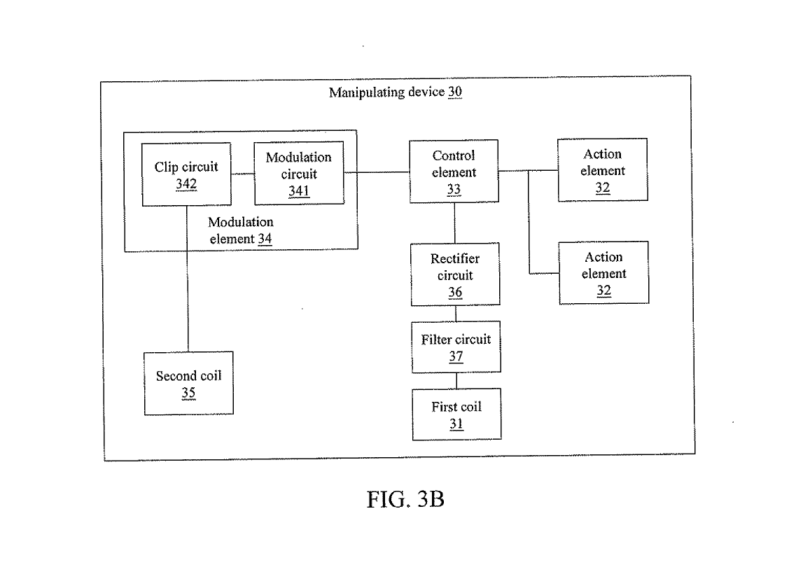

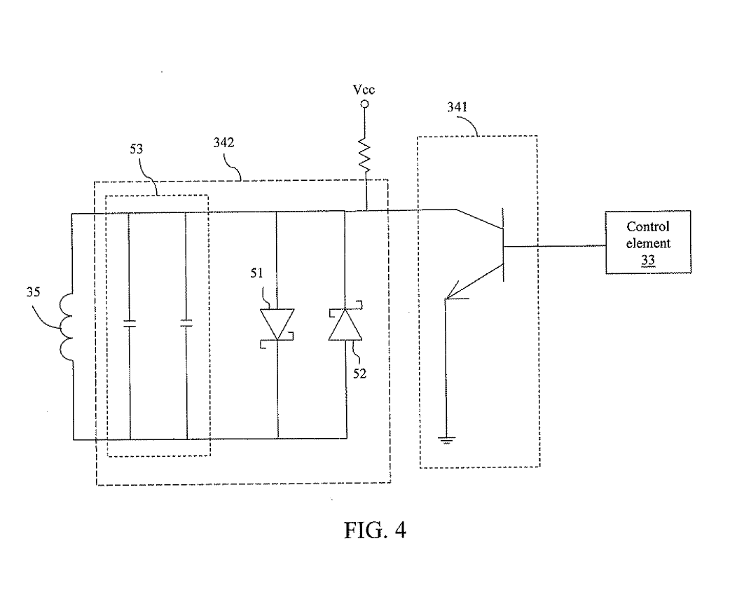

Referring to FIG. 3A, FIG. 3B, and FIG. 4, FIG. 3A and FIG. 3B are schematic block diagrams of a manipulating device according to different embodiments respectively, and FIG. 4 is a circuit diagram of a modulation unit according to an embodiment. In this and some other embodiments, a rectifier circuit 36 is arranged between the first coil 31 and the control unit 33. The rectifier circuit 36 is connected to the first coil 31 and the control unit 33, and is used for rectifying an electric signal and then outputting the rectified electric signal to the control unit 33. Further, in this and some other embodiments, a filter circuit 37 is disposed between the rectifier circuit 36 and the first coil 31, as shown in FIG. 3B. The electric signal is filtered and rectified before providing power for other units such as the control unit 33 and the modulation unit 34.

In this and some other embodiments, the modulation unit 34 comprises a modulation circuit 341 and a clip circuit 342. The modulation circuit 341 is connected to the control unit 33, and is used for generating a second modulated signal according to the first control signal and the second control signal. As shown in FIG. 4, in this and some other embodiments, the modulation circuit 341 is implemented as a transistor. The modulation circuit 341 is turned on according to the logic level of the first control signal or the logic level of the second control signal. The transistor is, for example, a bipolar junction transistor (BJT), a metal-oxide-semiconductor field-effect transistor (MOSFET), or a single electron transistor (SET). Hereinafter, the transistor is a BJT.

A base terminal of the transistor (the modulation circuit 341) is connected to the control unit 33, an emitter terminal of the transistor is grounded, and a collector terminal of the transistor is connected to an anode of a first Zener diode 51 and a cathode of a second Zener diode 52. The first Zener diode 51, the second Zener diode 52, a matching capacitor 53, and the second coil 35 are connected in parallel. The modulation circuit 341 outputs the second modulated signal to control the output of the clip circuit 342. Further, in this and some other embodiments, the modulation circuit 341 is implemented as an amplitude shift keying circuit, and outputs the second modulated signal having different amplitudes corresponding to the first control signal and the second control signal.

The clip circuit 342 is connected to the modulation circuit 341 and the second coil 35, and is used for clamping a voltage of the second modulated signal to generate the first modulated signal. In this and some other embodiments, the clip circuit 342 is implemented through a nonlinear unit. According to an embodiment, the clip circuit 342 comprises the first Zener diode 51, the second Zener diode 52, and the matching capacitor 53. The first Zener diode 51 is used for clamping a positive half cycle of the second modulated signal. The second Zener diode 52 is used for clamping a negative half cycle of the second modulated signal.

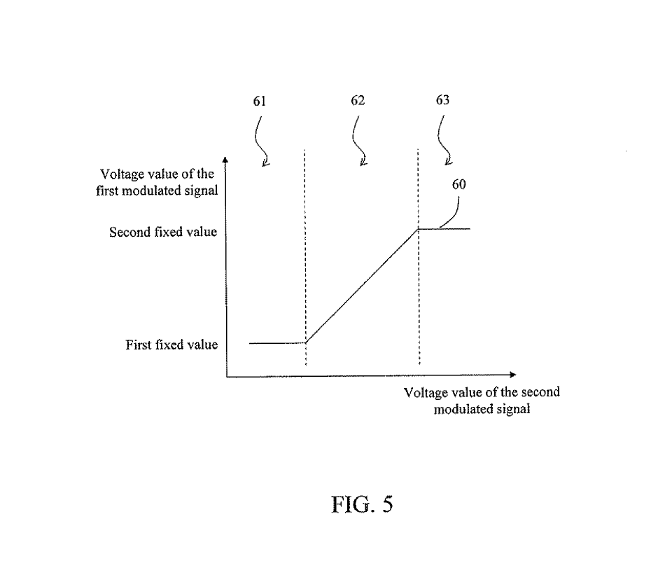

Referring to FIG. 5 for a conversion curve of the clip circuit 342, FIG. 5 shows an input to output voltage conversion curve 60. A horizontal axis represents a voltage value of the second modulated signal. A vertical axis represents a voltage value of the first modulated signal. When the voltage value of the second modulated signal is in a first range 61, the voltage value of the first modulated signal is maintained at a first fixed value. When the voltage of the second modulated signal is in a third range 63, the voltage of the first modulated signal is maintained at a second fixed value. When the voltage value of the second modulated signal is in a second range 62, the voltage value of the first modulated signal is directly proportional to the voltage value of the second modulated signal. Specifically, the first Zener diode 51 is used for providing an upper limit of the voltage value, the second Zener diode 52 is used for providing a lower limit of the voltage value, and the second range 62 is between the upper limit and the lower limit. When the voltage value of the second modulated signal is greater than the upper limit, the voltage value of the first modulated signal is clamped at the first fixed value. When the voltage value of the input signal is smaller than the lower limit, the voltage value of the output signal is clamped at the second fixed value.

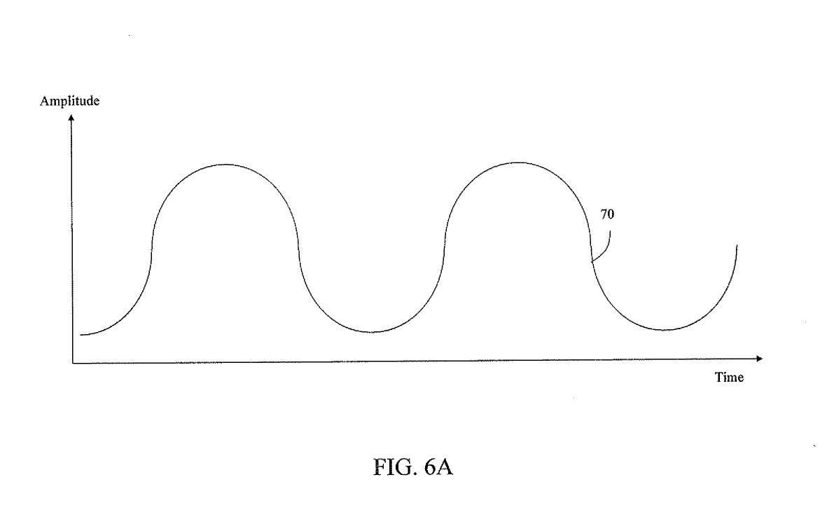

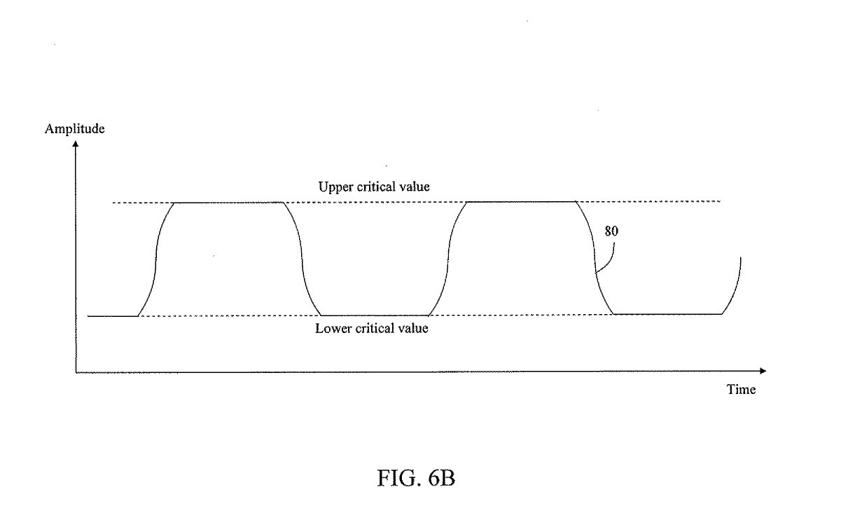

Referring to FIG. 6A and FIG. 6B, FIG. 6A is a waveform diagram of the voltage value of the second modulated signal according to an embodiment, and FIG. 6B is a waveform diagram of the voltage value of the first modulated signal according to the embodiment. FIG. 6A shows a voltage curve 70 of the second modulated signal, and FIG. 6B shows a voltage curve 80 of the first modulated signal.

When the voltage value of the second modulated signal is in the first range 61, the voltage value of the first modulated signal is equal to the voltage value of the second modulated signal. The second modulated signal is a sinusoidal signal. When the voltage value of the second modulated signal is in the positive half cycle, and the amplitude of the sine wave is greater than the upper limit, the voltage value of the first modulated signal is clamped at the upper limit. On the contrary, when the voltage value of the second modulated signal is in the negative half cycle, and the amplitude of the sine wave is smaller than the lower limit, the voltage value of the first modulated signal is clamped at the lower limit.

After the clip circuit 342 uses the first Zener diode 51 and the second Zener diode 52 to clamp the voltage of the second modulated signal, the first modulated signal having a plurality of high order harmonics is generated by using the matching capacitor 53 matching the second coil 35. The charging signal received by the first coil 31 is at a first frequency. The clip circuit 342 uses the first frequency as a fundamental frequency. The high order harmonics with a center frequency being a plurality of times of the fundamental frequency are generated by using resonance between the matching capacitor 53 and the second coil 35. In other words, the center frequency of the high order harmonics is a plurality of times of the first frequency, for example, twice, 3 times, or 4 times of the first frequency. In this and some other embodiments, a capacitance value of the matching capacitor 53 is designed according to the center frequency of the high order harmonics.

Taking the embodiment of FIG. 4 for example, when the control unit 33 outputs a high-level signal, the transistor (the modulation circuit 341) is on, the clip circuit 342 does not act but outputs a low-level signal. When the control unit 33 outputs a low-level signal, the transistor is off, and the clip circuit 342 outputs a high-level signal, that is, generates the high order harmonics.

The second modulated signal corresponds to the first control signal and the second control signal that are output alternately, so that after the second modulated signal is clamped and undergoes frequency multiplication, the first modulated signal corresponds to the first control signal and the second control signal that are output alternately. After receiving the first modulated signal, the second coil 35 wirelessly generates an output signal corresponding to the first modulated signal. The output signal has the first frequency and the high order harmonics. It can be regarded that the output signal carries the first control signal for positioning and the second control signal into which the action signal is encoded.

After the sensing unit 42 of the sensing device 40 receives the output signal from the second coil 35, in this and some other embodiments, processing such as filtering is performed to filter the output signal to obtain contents of the first control signal and of the second control signal, and the directional control input signal is generated according to the first control signal and the second control signal.

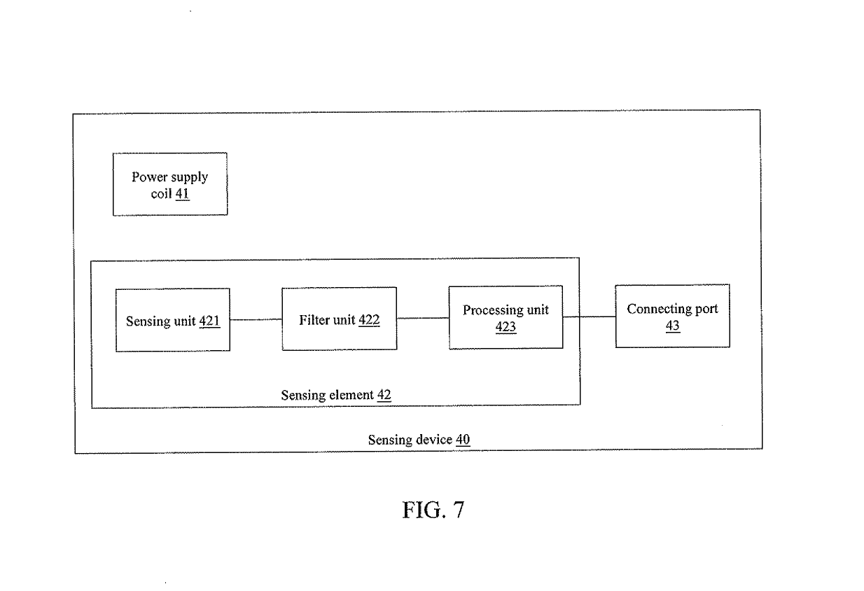

Referring to FIG. 7, FIG. 7 is a schematic block diagram of the sensing unit according to an embodiment.

In this and some other embodiments, a sensing unit 42 comprises a sensing unit 421, a filter unit 422, and a processing unit 423. In this and some other embodiments, the sensing unit 421 uses an antenna or a coil to receive the output signal. The filter unit 422 filters out the signal at the first frequency in the output signal, and only transmits the high order harmonics to the processing unit 423. In this and some other embodiments, after demodulating the high order harmonics, the processing unit 423 obtains the contents of the first control signal and of the second control signal corresponding to the first period and the second period and detects coordinate values according to the first control signal. The processing unit 423 also determines, according to the second control signal, whether the button is pressed or the value of the pen pressure. In this and some other embodiments, the processing unit 423 transmits a final processing result, comprising the coordinate values and whether the button is pressed or the value of the pen pressure, to a computer through a connecting port 43.

Further, according to an embodiment, the modulation unit 34 generates a plurality of first high order harmonics according to the first control signal, and generates a plurality of second high order harmonics according to the second control signal, and the first high order harmonics and the second high order harmonics have different center frequencies. For example, the center frequency of the first high order harmonics is twice the first frequency, and the center frequency of the second high order harmonics is three times of the first frequency. In this and some other embodiments, the sensing unit 42 comprises two filter units 422, so as to filter out the first high order harmonics and the second high order harmonics respectively.

In view of the above, the manipulating device receives power through the power supply coil and the first coil, saving the need of an additional battery. The conventional oscillator circuit is not used in the manipulating device, and instead the modulation unit and the second coil transmit the output signal to the sensing device. The existence and inexistence of the high order harmonics directly correspond to the low level and the high level in the first control signal or in the second control signal, thereby resulting in less susceptibleness to interference. Power consumed by the modulation unit and the second coil is lower than that consumed by the oscillator circuit, so that overall power consumption of the manipulating device is decreased.

What is claimed is:

1. A manipulating device, comprising:
a first coil, used for receiving a charging signal, and incurring electromagnetic resonance because of the charging signal, so as to generate an electric signal;
at least one action unit, used for generating at least one action signal;
a control unit, connected to the first coil and the action unit, and used for alternately generating a first control signal according to the electric signal in a first period and generating a second control signal according to the at least one action signal in a second period;
a modulation unit, connected to the control unit, and used for modulating the first control signal and the second control signal to generate a first modulated signal; and
a second coil, connected to the modulation unit, and used for generating an output signal according to the first modulated signal.

2. The manipulating device according to claim 1, wherein the modulation unit comprises:
a modulation circuit, connected to the control unit, and used for generating a second modulated signal according to the first control signal and the second control signal; and
a clip circuit, connected to the modulation circuit and the second coil, and used for clamping a voltage of the second modulated signal to generate the first modulated signal.

3. The manipulating device according to claim 2, wherein the charging signal is at a first frequency, and the output signal has the first frequency and a plurality of high order harmonics of the first frequency.

4. The manipulating device according to claim 3, wherein the clip circuit comprises:
a first Zener diode, used for clamping a positive half cycle of the second modulated signal;
a second Zener diode, used for clamping a negative half cycle of the second modulated signal; and
a matching capacitor, matching the first coil to generate the high order harmonics.

5. The manipulating device according to claim 3, wherein a center frequency of the high order harmonics is multiple of the first frequency.

6. A directional input apparatus, comprising:
a sensing device, comprising:
a power supply coil, used for generating a charging signal; and
a sensing unit, used for generating a directional control input signal according to an output signal; and
a manipulating device, comprising:
a first coil, used for receiving the charging signal, and incurring electromagnetic resonance through the charging signal, so as to generate an electric signal;
at least one action unit, used for generating at least one action signal;
a control unit, connected to the first coil and the action unit, and used for alternately generating a first control signal according to the electric signal in a first period and generating a second control signal according to the at least one action signal in a second period;
a modulation unit, connected to the control unit, and used for modulating the first control signal and the second control signal to generate a first modulated signal; and
a second coil, connected to the modulation unit, and used for generating the output signal according to the first modulated signal.

7. The directional input apparatus according to claim 6, wherein the modulation unit comprises:
a modulation circuit, connected to the control unit, and used for generating a second modulated signal according to the first control signal and the second control signal; and
a clip circuit, connected to the modulation circuit and the second coil, and used for clamping a voltage of the second modulated signal to generate the first modulated signal.

8. The directional input apparatus according to claim 7, wherein the charging signal has a first frequency, and the output signal has the first frequency and a plurality of high order harmonics of the first frequency.

9. The directional input apparatus according to claim 8, wherein the clip circuit comprises:
a first Zener diode, used for clamping a positive half cycle of the second modulated signal;
a second Zener diode, used for clamping a negative half cycle of the second modulated signal; and
a matching capacitor, matching the second coil to generate the high order harmonics.

10. The directional input apparatus according to claim 8, wherein a center frequency of the high order harmonics is multiple of the first frequency.

11. The directional input apparatus according to claim 6, wherein the sensing unit filters the output signal to obtain the first control signal and the second control signal, and generates the directional control input signal according to the first control signal and the second control signal.
